(19) United States
(12) Patent Application Publication
(10) Pub. No.: US 2026/0018023 A1
(43) Pub. Date: Jan. 15, 2026

(54) SYSTEMS AND METHODS RELATED TO PRIZE REDEMPTION

(71) Applicant: BIG DADDY GAMES, LLC, MENASHA, WI (US)

(72) Inventor: HOWARD SMOYER, AURORA, IL (US)

(21) Appl. No.: 19/256,677

(22) Filed: Jul. 1, 2025

Related U.S. Application Data
(60) Provisional application No. 63/667,994, filed on Jul. 5, 2024.

(51) Int. Cl. G07F 17/32

(52) U.S. Cl. CPC G07F 17/3246; G07F 17/3209; G07F 17/3211; G07F 17/3253; G07F 17/3255

(57) ABSTRACT

Systems and methods according to the present invention relate generally to prize redemption. Specifically, the present invention relates to a system and method of redeeming prizes from tokens (pull tabs, tickets, etc.) at a specialized machine which may offer a player a variety of pay out options, including cash, gift cards, and/or direct deposit. A pull tab according to the present invention includes a scannable code (bar code, QR-code, etc.), which may be scanned at a specialized machine (pull tab-dispensing machine and/or separate standalone machine) to pay out a prize directly to the player or to transfer a prize to an account registered to the player, such as a gaming account or bank account.

### BACKGROUND OF THE INVENTION

There are many ways to win a prize. A prize winner is often determined by an assignment of some indicator (a number or series of numbers) to a person and, often, a then randomized occurrence to select an indicator to win the prize. The assignment of the indicator to a person may be predetermined by the person (e.g., through selected lottery numbers), serially provided to a person (e.g., rolled raffle tickets), or randomly selected by the person (e.g., selected from a pool of indicators). In the latter case, the indicator may be predetermined as a winner or loser, the prize being associated with the indicator prior to selection by the person. In the former two situations, a later event (e.g., a drawing or other randomized event) is required. Then, if a person's indicator is somehow identified (e.g., drawn, pulled, etc.) in the later event, the prize is associated with the indicator.

While many prize awards are efficiently run as a particular event at a particular time, by a particular organization, thus lending themselves to the focus of a dedicated person or group, some are done tangentially to other activities, including business activities. When a prize award is required in addition to management of other business activities, the management of the award can distract a person from such other activities, thereby reducing efficiency of both the other activities and the prize award.

A prime example of prior reduced efficiencies arises in businesses that offer drawings or prizes that must be redeemed through an employee. For example, in Wisconsin and in up to an additional 40 States, often Veterans and Fraternal Clubs, Bingo Halls, and many bar and restaurant businesses have machines that dispense pull tabs, which are physical, multi-layered paper tickets containing symbols hidden behind a series of perforated tabs. Players pull back and/or remove the perforated tabs to reveal combinations of symbols, with different combinations yielding different prizes. To redeem these prizes, however, players must bring the winning ticket to the attention of an attendant, such as an employee of the business or a volunteer. This process is obviously inefficient for both the player and the attendant. The player must find an attendant, get their attention, hand over their winning ticket(s), and wait for the attendant to manually verify and add up totals of winnings, then to return with their prize. In theory, this does not seem too arduous, but it can be exceedingly time consuming when the business is busy. Further, the employee must choose to either make the player wait to obtain their prize or to cease performing their normal tasks to redeem the player's winning ticket, neither of which are optimal options.

Therefore, more efficient systems and methods for prize verification and award distribution are sought in the art.

### SUMMARY OF THE INVENTION

Embodiments of systems and methods according to the present invention relate generally to methods and devices for improved efficiencies in prize redemption. Specifically, the present invention involves a specialized ticket that may be redeemed using a specialized redemption machine for an award in a form of currency, in a form of credit for purchase of additional tickets, or, possibly, transferred directly to a user's bank account.

According to an aspect of an embodiment of a system according to the present invention, the system includes a scanner and a dispensing mechanism. A container houses a supply of prizes. Electronic circuitry includes nonvolatile electronic memory and a CPU in electrical communication with the scanner, the dispensing mechanism, and the nonvolatile memory. The CPU receives information from the scanner as a result of scanning a code, the CPU queries the nonvolatile memory, and, as a result of the query either transmits or prevents transmission of a dispensing instruction to the dispensing mechanism. In response to a dispensing instruction, the dispensing mechanism receives a prize from the container and positions the prize to be accessible from outside the system. Optionally, as a result of the query, rather than automatically transmitting a dispensing instruction, an indication of options including a prize type and/or amount may be displayed to a user, inviting a selection by the user. In response to the selection by the user, a dispensing instruction may be transmitted to the dispensing mechanism.

According to another aspect of an embodiment of a system according to the present invention, the scanner is a one-dimensional scanner and the code may be a bar code. Additionally or alternatively, the scanner is a two-dimensional scanner and the code may be a QR code. Additionally or alternatively, the scanner is a digital camera (e.g., CMOS or CCD) and the code may be at least one of a bar code, a QR code, a two-dimensional graphical image, a machine-generated alphanumeric characters, handwriting, a universally unique identifier (UUID), and a globally unique identifier (GUID).

According to still another aspect of an embodiment of a system according to the present invention, the code is located on a physical game ticket (e.g., printed or etched on paper or other object, such as a promotional object). The game ticket may include a first layer of one or more perforated tabs, one of the tabs covering a second underlying layer comprising the code. The physical game ticket may have been dispensed by the system including the scanner, or the ticket may have been dispensed by another, separate machine, or by hand.

According to yet another aspect of an embodiment of a system according to the present invention, the prizes are of one or more types selected from the group consisting of monetary currency; a gift certificate; a store gift card; a general use prepaid card; a loyalty, award, or promotional gift card; a ticket including a second code; and a novelty item.

According to a further aspect of an embodiment of a system according to the present invention, the system further includes a housing enclosing the container, the electronic circuitry, and a majority of the dispensing mechanism. The scanner is preferably at least one of supported by and accessible through the housing. The system may further include an interactive user interface accessible through or on the housing, the user interface comprising at least one of a capacitive touchscreen and a visual display screen in combination with one or more physical buttons. The user interface preferably displays or indicates options for a user to input information or make a selection, the options being navigable through at least one of the touchscreen and the physical buttons.

According to a further aspect of an embodiment of a system according to the present invention, the electronic circuitry further comprising an internet protocol physical layer operatively coupled to the CPU. The system is preferably configured to operate as an automatic teller machine (ATM).

According to an aspect of another embodiment of a system according to the present invention, the system includes a scanner, a dispensing mechanism, a container that houses a supply of prizes, and electronic circuitry including nonvolatile electronic memory, a CPU in electrical communication with the scanner, the dispensing mechanism, and the nonvolatile memory, and an internet protocol physical layer operatively coupled to the CPU. A housing preferably encloses the container, the electronic circuitry, and a majority of the dispensing mechanism. An interactive user interface is preferably accessible through or provided on the housing, the user interface comprising at least one of a capacitive touchscreen and a visual display screen in combination with one or more physical buttons. The CPU receives information from the scanner as a result of scanning a code, queries the nonvolatile memory, and, as a result of the query causes a display on the interactive user interface of at least one of an indication of a prize, a monetary prize value and an indication of no prize value. If there is an indication of prize value displayed, a user option is also displayed on the interactive user interface, the user option allowing a selection. User options may be one or more a prize to be dispensed by the dispensing mechanism, an amount of currency to be dispensed by the dispensing mechanism, and/or an operation of transmitting a monetary prize value to a bank account over a wide area network.

### BRIEF DESCRIPTION OF THE DRAWINGS

FIG. 1 is a perspective view of a specialized ticket according to the present invention.

FIG. 2 is a perspective view of the process of scanning the specialized ticket of FIG. 1 using a redemption machine according to the present invention.

FIG. 3 is a block diagram of a first embodiment of the redemption machine, taken along the 3-3 line of FIG. 2.

FIG. 4 is a block diagram of a second embodiment of the redemption machine, taken along the same 3-3 line of FIG. 2.

FIG. 5 is a perspective view of a third embodiment of the redemption machine.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention.

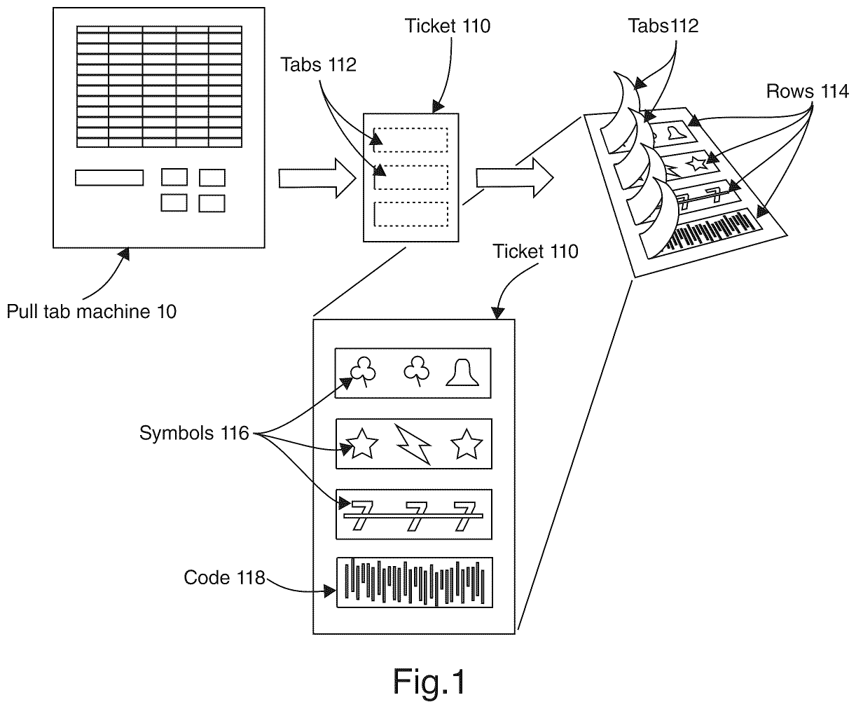

Turning now to the Figures, embodiments of systems and methods related to prize redemption may be seen. Specifically, as seen in FIG. 1-3, a system 100 related to prize redemption may generally comprise a specialized ticket 110 that can be redeemed in a variety of methods by a specialized redemption machine 120. The system 100 may provide efficient payment options for users who have played a game and received a ticket 110. Rather than having to wait for a store and/or bar worker, the redemption machine 120 preferably scans the ticket 110 and provides a variety of options for the user to receive their prize.

As seen in FIG. 1, the specialized ticket 110 may generally be a printed ticket, listing the user's ending point and/or cash total when they cashed out, or a more conventional game ticket, such as a pull tab. No matter the embodiment of the ticket 110, each ticket 110 preferably comprises a printed scannable code 118, which preferably contains information related to the player and/or last game played. Such information may include a player name, account details, account balance, payout balance, and/or other possible identifying information. The ticket 110 may preferably be obtained from a source outside the system 100, such as a game or pull-tab dispensing machine 10, or even simply being handed to a user by another person, such as a bartender. In other embodiments, the ticket 110 may be printed and/or dispensed by the same machine that can be used to redeem a prize indicated by a code on the ticket 110.

In embodiments wherein the ticket 110 comprises a pull tab, the ticket 110 preferably comprises at least one, and most preferably at least two, perforated tabs 112, which may be peeled back to reveal printed rows 114 in a second layer underneath. Preferably, one of the printed rows comprises the printed scannable code 118 (e.g. a bar code or a quick response (QR) code), while the other rows comprise symbols 116. Winning tickets 110, like regular pull tabs, preferably include at least one row where each symbol 116 matches and/or a row wherein the symbols 116 are instead replaced by a notice stating the winning prize. Non-winning tickets preferably comprise at least one row where not all symbols 116 match and/or no winning notice.

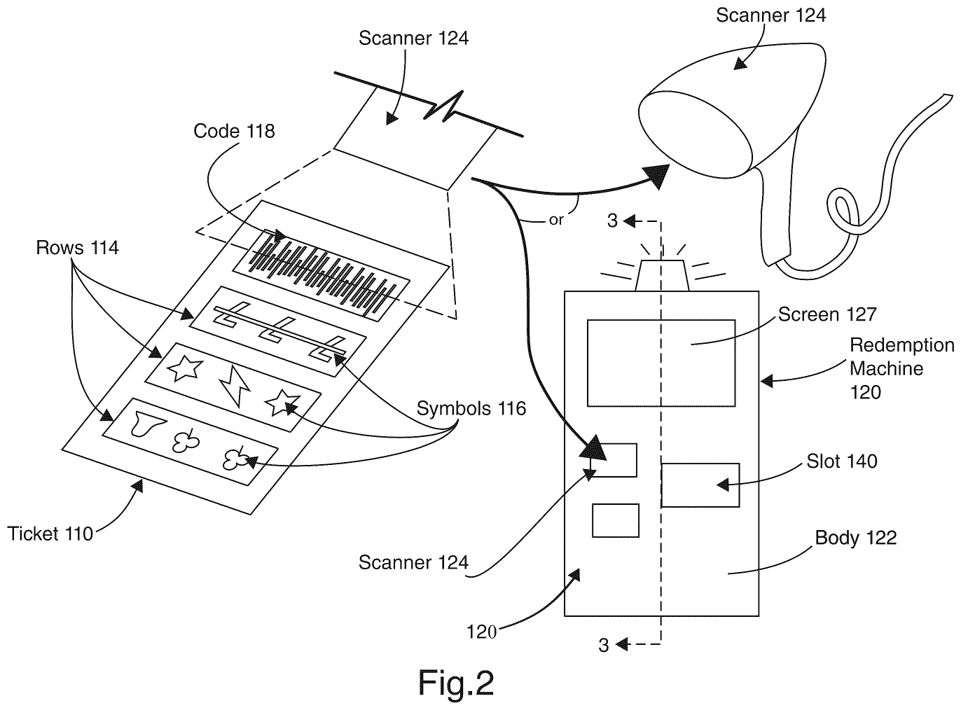

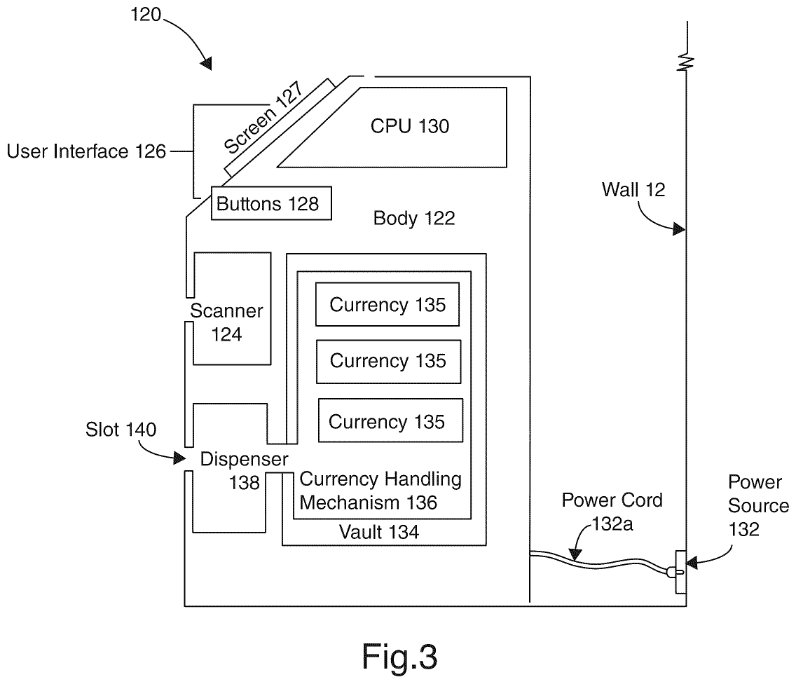

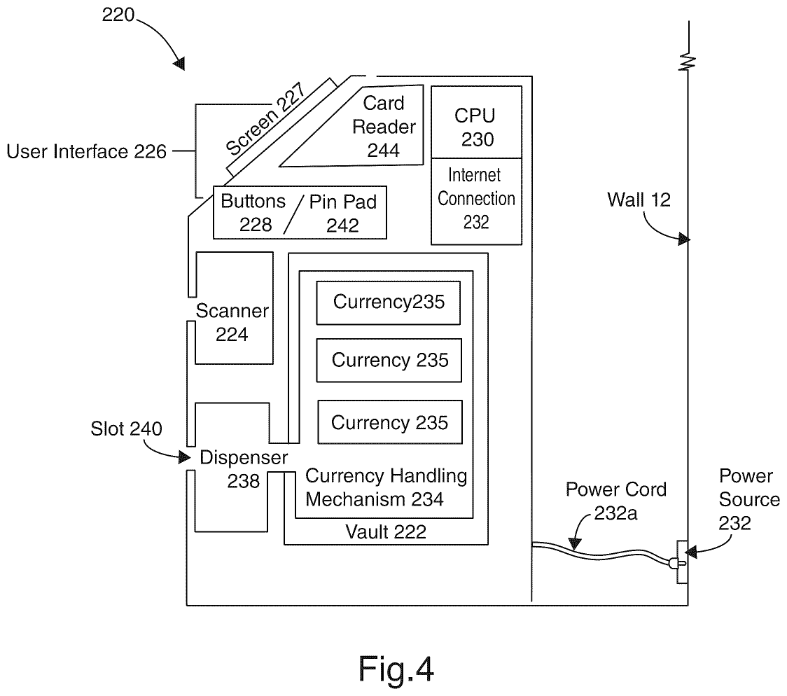

To redeem such ticket, the system 100 further comprises a redemption machine 120 comprising a housing or body 122 supporting a scanner 124, a user interface 126, and a prize dispenser 138, each being in electronic communication with a controller, such as a central processing unit (CPU) 130, and a power source 132. The body 122 also preferably houses a container, such as a vault 134. The redemption machine body 122 is preferably similar in build and structure to a standalone ATM body, being manufactured from metal (e.g. sheet metal and/or stainless steel) and/or hard plastic to prevent unwarranted or unauthorized entry. The body 122 may even be reinforced by metal (e.g. steel) for an added layer of protection. The shape of the body 122 may be substantially rectangular, as seen in FIG. 2. Alternatively, the body 122 may be shaped such that the screen 127 is angled to face slightly upward, as known in the art and routinely used in ATM designs. Such a configuration can be seen in FIGS. 3 and 4. The body 122 also preferably comprises a dispenser 138, where a prize (e.g., currency 135 or optionally another ticket 110) corresponding to the prize won by or owed to a user according to the data stored on the ticket code 118 made be provided.

Preferably mechanically and electrically connected to the body 122, the scanner 124 may be provided in a variety of fashions as seen in FIG. 2. For instance, one embodiment of the scanner 124 according to the present invention may be a conventional handheld scanner of the kind known in the art. This type of scanner 124 is preferably attached to the body 122 using a cord 124a. Alternatively, the scanner 124 may be built into the body 122 and have a direct connection to the CPU 130 with no cord 124a needed. In either configuration, the scanner 124 preferably scans the code on the ticket 110 and transfers the information to the CPU 130.

Also preferably built into the body 122 is the user-interface system 100, comprising a graphic and text display screen 127 and user-input buttons 128. Facing out of, and preferably supported by, the body 122, the graphic and text display screen 127 preferably graphically and/or textually displays information related to the ticket 110 and/or the user and/or the user's account may be displayed. The screen 127 may be a conventional screen known in the art. Similarly supported by the body 122, the buttons 128 allow the user to navigate the user-interface, which is controlled by the CPU 130 and shown in real time on the display screen 127. Types of buttons preferably include confirm and deny buttons and may further include navigational buttons, numeral buttons, and/or alphabetical buttons. Additionally or alternatively to physical buttons, the system 100 may incorporate a display screen 127 with touchscreen (e.g., capacitive touchscreen) capabilities and a user interface 126 incorporating digital (e.g., soft) buttons 128.

Preferably housed within the body 122, the CPU 130 may be a conventional CPU known in the art preferably comprising both short term (aka random access memory (RAM)) and long term (aka read-only memory (ROM)) storage capabilities. The CPU 130 is preferably programmed and/or configured to receive input data from the scanner 124 and/or user-input buttons 128, store it in either or both of the RAM and ROM, and graphically and/or textually display the data on the screen 127. The CPU 130 preferably draws power from the power source 132, which may be a battery (e.g. a conventional or rechargeable battery), but is more preferably a conventional outlet in a wall 12 electronically coupled to the redemption machine 120 through a power cord 132a.

Also preferably housed within the body 122, the container or vault 134 is preferably made of reinforced metal to prevent unauthorized entry. The container 134 preferably houses a supply of prizes (e.g, currency 135, such as U.S. dollars). Additionally or alternatively, the container 134 may house other kinds of prize items for distribution as well, such as gift cards associated with national, regional, and/or local businesses and brands, most preferably a gift card redeemable at the place of business or location within which the system 100 is located.

Prizes may include one or more of monetary currency, a gift certificate, a store gift card, a general-use prepaid card, and/or one or more tickets 110 including another code 118. Additionally or alternatively a type of prize may be a loyalty, award, or promotional gift card and/or a novelty item. Monetary currency is generally understood in the art to be coins or bills issued by a governmental agency and to be used to carry out monetary exchanges. Examples of currency are the dollar (e.g., U.S., East Caribbean, Arab Accounting, Australian, Bahamian, Barbados, Belize, Bermudian, Brunei, Canadian, Cayman Islands, New Zealand, Fiji, Guyana, Hong Kong, Jamaican, Liberian, Namibia, Singapore, Solomon Islands, Surinam, New Taiwan, and Trinidad and Tobago), the Dinar (e.g., Algerian, Arab Accounting, Bahraini, Iraqi, Jordanian, Kuwaiti, Libyan, Serbian, and Tunisian), the Euro, and currency of other countries, and all denominations thereof.

The following definitions are generally accepted and provided in U.S. Federal Regulations 12 C.F.R. § 1005.20. A gift certificate is a card, code, or other device that is: (i) Issued on a prepaid basis primarily for personal, family, or household purposes to a consumer in a specified amount that may not be increased or reloaded in exchange for payment; and
(ii) Redeemable upon presentation at a single merchant or an affiliated group of merchants for goods or services.

A store gift card is a card, code, or other device that is:
(i) Issued on a prepaid basis primarily for personal, family, or household purposes to a consumer in a specified amount, whether or not that amount may be increased or reloaded, in exchange for payment; and
(ii) Redeemable upon presentation at a single merchant or an affiliated group of merchants for goods or services.

A general-use prepaid card is a card, code, or other device that is:
(i) Issued on a prepaid basis primarily for personal, family, or household purposes to a consumer in a specified amount, whether or not that amount may be increased or reloaded, in exchange for payment; and
(ii) Redeemable upon presentation at multiple, unaffiliated merchants for goods or services, or usable at automated teller machines.

A loyalty, award, or promotional gift card is a card, code, or other device that:
(i) Is issued on a prepaid basis primarily for personal, family, or household purposes to a consumer in connection with a loyalty, award, or promotional program;
(ii) Is redeemable upon presentation at one or more merchants for goods or services, or usable at automated teller machines;

While U.S. federal regulations exclude certain cards, codes, or other devices, the same exclusions are not provided herein with respect to prizes. That is, a prize to be dispensed according to the present invention may further include one or more of a card, code, or other device that is:
(1) Useable solely for telephone services;
(2) Reloadable and not marketed or labeled as a gift card or gift certificate. For purposes of this paragraph (b)(2), the term “reloadable” includes a temporary non-reloadable card issued solely in connection with a reloadable card, code, or other device;
(3) A loyalty, award, or promotional gift card;
(4) Not marketed to the general public;
(5) Issued in paper form only; or
(6) Redeemable solely for admission to events or venues at a particular location or group of affiliated locations, or to obtain goods or services in conjunction with admission to such events or venues, either at the event or venue or at specific locations affiliated with and in geographic proximity to the event or venue.

Examples of novelty items that may be dispensed are collector or trading cards (e.g., cards depicting sports players, celebrities, animals, etc.), game cards (e.g., Pokémon, Yu-Gi-Oh!, Magic: The Gathering), pogs (e.g., game pieces or milk caps), novelty certificate (e.g., achievement certificate), or lenticular lens cards.

The vault 134 may also house and incorporate a handling mechanism 136 known in the art. When instructed by the CPU 130, the handling mechanism 136 collects the prize (e.g., currency 135 or card) and transports it to a dispenser. As the scanner 124 reads a user's ticket code 118, it transfers data to the CPU 130, which then instructs the handling mechanism 136 to transport the prize (currency, card, or novelty) out of the vault 134 and to the dispenser 138.

The dispenser 138 is preferably supported by the body 122 and comprises a mechanism for receiving currency 135 from the currency handling mechanism 136 and transferring it through a slot 140 in the body 122, where the user may take it. The dispenser 138 may be a conventional dispenser known in the art, such as the type used in ATM manufacturing and building.

In a second embodiment of the present invention as seen in FIG. 4, a system 200 may include all of the systems and functions as described above, while further acting as a functional ATM itself. In the following description, like numbers are assigned to like parts described above. For example, in a second embodiment of the present invention, the user interface 226 may further comprise a pin pad 242 and card reader 244 supported by the body 222. Both the pin pad 242 and card reader 244 may be conventionally manufactured and are well known in the art.

Further, the CPU 230 in the system 200 preferably comprises an internet connection 232, which could be wired or wireless (e.g. Wi-Fi or Bluetooth®). In such configurations, the CPU 230 is preferably preprogrammed or preconfigured to connect with banking systems over the internet. The system 200 is therefore able to provide another option for a player to redeem winning ticket codes 118. Instead of requesting a currency 135 return, such as cash or gift cards as described above, the system 200 allows users to wire their winnings directly to their bank account over the internet.

When a user puts their debit card into the card reader 244 and enters their bank pin using the pin pad 242, the system 200 may preferably act with all functions of a normal ATM, such as allowing users to make withdrawals and/or deposits from their bank account. In such configurations, the body 222 preferably comprises a dual dispenser/receiver 238, which may dispense currency 235 received from the currency handling mechanism 236 as described for dispenser 138 above, while also accepting currency 235 (i.e. cash) from the user to deposit into the vault 234. The system 200 also allows for direct transfer of funds from a winning ticket to the user's bank account, which removes the extra steps of requiring a user to be dispensed money from a winning ticket and then depositing that money into their bank account in a different way. This process efficiently transfers winnings to the user in the way they best see fit, be it direct transfer to a bank account or dispensing currency 235 (money and/or gift cards) to the user immediately from the redemption machine 220.

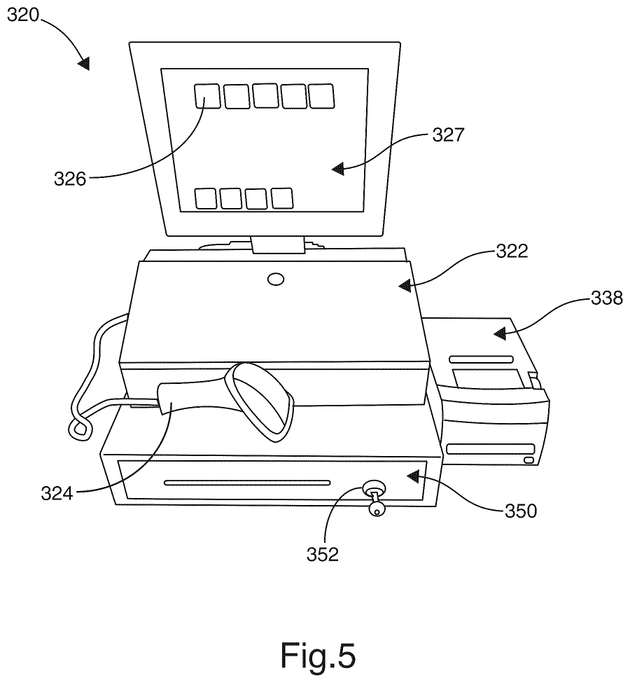

In a third embodiment of the present invention as seen in FIG. 5, a system 300 preferably comprises an alternative composition of a redemption machine 320. This embodiment comprises a Point-Of-Sale (POS) type terminal for redemption machine 320, where the user most commonly will be an employee or an attendant. The POS type redemption machine 320 offers greater efficiency, security, and accuracy, as compared to manual operations, in verifying, accumulating, and totaling prizes for the player. In some cases, and with some functions, the user may be the player. In the following description, like numbers are assigned to like parts described above. Similar to the machines 120 and 220 described above, redemption machine 320 preferably comprises a CPU 330 (not shown) enclosed within a body or housing 322, the body 322 supporting a user interface 326 comprising a screen 327. The body 322 preferably further supports a scanner 324, which may either be a separate scanner 324 wired or wirelessly attached to the machine 320 or built into the body 322 itself, and a dispenser 338, which may dispense tickets 310, currency 335, and/or transaction receipts depending on the needs of the user and/or the embodiment of the machine 320. In some cases, the redemption machine 320 may preferably be capable of performing the same functions as the machines 120 and 220 described above.

However, the redemption machine 320 preferably differs from the machines 120 and 220 described above in that the machine 320 preferably comprises a till 350, which is in electronic communication with the CPU 330. The till 350 preferably stores the currency 335, rather than a vault 134/234 as described above. When a user scans a ticket 310 at the redemption machine 320, the CPU 330 preferably processes the information and automatically updates the player's account (if they have one) and/or allows the player to claim their prize immediately. If the user chooses to claim their prize or withdraw from their account, they can preferably interact with the user interface 326 to do so.

The till 350, which preferably contains one or more currencies 335, which may be cash, gift cards, and/or other forms of currency as described above, opens and an attendant or business employee may withdraw the currency 335 to transfer to the user. The till 350 may be a standalone till 350 (i.e. a separate article from the body 322 connected by wire or wirelessly), but is preferably mechanically connected to the body 322, as seen in FIG. 5. The till 350 also preferably comprises a lock 352, such as a pad lock or key lock built into the till 350, for security.

In some configurations of the system 100/200/300 wherein the CPU 130/230/330 comprises an internet connection, the system 100/200/300 may preferably allow a user to set up and maintain an account using the user interface 126/226/326. On this account, and using the user interface 126/226/326, the user may track information related to gaming habits, including winnings, games played, locations played at, account balance, etc. This account set-up allows players yet another option for what to do with prizes. When users scan their ticket 110/210/310 when signed into their account, they also have the option of leaving the prize in their account balance to pay out (via currency 135/235/335 such as cash and/or gift cards) or transfer to their bank account at a different time.

In further embodiments of the present invention, the redemption machine 120/220/320 and the pull tab machine 10 may be the same machine, or the redemption machine 120/220/320 may be operatively coupled to and/or supported by the pull tab machine 10. For instance, the redemption machine 120/220/320 (or as combined with the pull tab machine 10) may further comprise a ticket reservoir (not pictured) mechanically and electrically coupled to the dispenser 138/238/338. In such embodiments, the redemption machine 120/220/320 may act as a substantially one-stop shop, allowing players to be the user to both buy tickets 110/210/310 and redeem them according to the processes described above. In some cases, the user may immediately reuse redeemed credits to dispense more tickets 110/210/310, may redeem the credits for other for other forms of currency 135/235/335, or may transfer the credits to a linked bank account as described above.

The foregoing is considered as illustrative only of the principles of the invention. Furthermore, because numerous modifications and changes will readily occur to those skilled in the art, it is not desired to limit the invention to the exact construction and operation shown and described. While the preferred embodiment has been described, the details may be changed without departing from the invention.

What is claimed is:

1. A system comprising:
a scanner;
a dispensing mechanism;
a container that houses a supply of prizes;
electronic circuitry comprising nonvolatile electronic memory and a CPU in electrical communication with the scanner, the dispensing mechanism, and the nonvolatile memory;
wherein the CPU receives information from the scanner as a result of scanning a code, queries the nonvolatile memory, and, as a result of the query either transmits or prevents transmission of a dispensing instruction to the dispensing mechanism,
wherein in response to the dispensing instruction, the dispensing mechanism receives a prize from the container and positions the prize to be accessible from outside the system.

2. The system according to claim 1, wherein the scanner is a one-dimensional scanner.

3. The system according to claim 2, wherein the code is a bar code.

4. The system according to claim 1, wherein the scanner is a two-dimensional scanner.

5. The system according to claim 4, wherein the code is a QR code.

6. The system according to claim 1, wherein the scanner is a digital camera.

7. The system according to claim 6, wherein the code is at least one of a bar code, a QR code, a two-dimensional graphical image, a machine-generated alphanumeric characters, handwriting, a universally unique identifier (UUID), and a globally unique identifier (GUID).

8. The system according to claim 1, wherein the code is located on a physical game ticket.

9. The system according to claim 8, wherein the game ticket comprises a first layer of one or more perforated tabs, one of the tabs covering a second underlying layer comprising the code.

10. The system according to claim 8, wherein the physical game ticket was not dispensed by the system.

11. The system according to claim 1, wherein the prizes are of one or more types selected from the group consisting of monetary currency; a gift certificate; a store gift card; a general use prepaid card; a loyalty, award, or promotional gift card; a ticket including a second code; and a novelty item.

12. The system according to claim 1, the system further including a housing enclosing the container, the electronic circuitry, and a majority of the dispensing mechanism.

13. The system according to claim 12, wherein the scanner is at least one of supported by and accessible through the housing.

14. The system according to claim 12, the system further comprising an interactive user interface accessible through the housing, the user interface comprising at least one of a capacitive touchscreen and a visual display screen in combination with one or more physical buttons.

15. The system according to claim 14, wherein the user interface displays options for a user to input information, the options being navigable through at least one of the touchscreen and the physical buttons.

16. The system according to claim 1, the electronic circuitry further comprising an internet protocol physical layer operatively coupled to the CPU.

17. The system of claim 16, wherein the system is also configured to operate as an automatic teller machine (ATM).

18. A system comprising:
a scanner;
a dispensing mechanism;
a container that houses a supply of prizes;
electronic circuitry comprising nonvolatile electronic memory, a CPU in electrical communication with the scanner, the dispensing mechanism, and the nonvolatile memory, and an internet protocol physical layer operatively coupled to the CPU;
a housing enclosing the container, the electronic circuitry, and a majority of the dispensing mechanism; and
an interactive user interface accessible through the housing, the user interface comprising at least one of a capacitive touchscreen and a visual display screen in combination with one or more physical buttons;
wherein the CPU receives information from the scanner as a result of scanning a code, queries the nonvolatile memory, and, as a result of the query causes a display on the interactive user interface of at least one of an indication of monetary prize value and an indication of no prize value,
wherein, if there is an indication of prize value displayed, a user option is also displayed on the interactive user interface, the user option allowing a selection between at least an operation of dispensing a prize using the dispensing mechanism and an operation of transmitting the monetary prize value to a bank account over a wide area network.
